(19) United States
(12) Patent Application Publication
(10) Pub. No.: US 2011/0102334 A1
(43) Pub. Date: May 5, 2011

(54) METHOD AND APPARATUS FOR DETERMINING ADJUSTED POSITION FOR TOUCH INPUT

(75) Inventors: Ashley Colley, Oulu (FI); Marjut Anette Poikola, Oulu (FI); Sari Martta Johanna Komulainen, Oulu (FI)

(73) Assignee: NOKIA CORPORATION, Espoo (FI)

(21) Appl. No.: 12/612,476

(22) Filed: Nov. 4, 2009

(51) Int. Cl. G06F 3/041

(52) U.S. Cl. 345/173

(57) ABSTRACT

An apparatus, comprising a processor, memory including computer program code, the memory and the computer program code configured to, working with the processor, cause the apparatus to perform at least receiving indication of a touch input associated with a touch display, comprising position information associated with the touch input, determining a hand orientation associated with the touch input, and determining an adjusted position to associate with the touch input based at least in part on the determined hand orientation, and the position information associated with the touch input is disclosed.

### TECHNICAL FIELD

The present application relates generally to touch input.

### BACKGROUND

There has been a recent surge in the use of touch displays on electronic devices. The user may provide input to the electronic device to perform various operations.

### SUMMARY

Various aspects of examples of the invention are set out in the claims.

An apparatus, comprising a processor, memory including computer program code, the memory and the computer program code configured to, working with the processor, cause the apparatus to perform at least receiving indication of a touch input associated with a touch display, comprising position information associated with the touch input, determining a hand orientation associated with the touch input, and determining an adjusted position to associate with the touch input based at least in part on the determined hand orientation, and the position information associated with the touch input is disclosed.

A method, comprising receiving indication of a touch input associated with a touch display, comprising position information associated with the touch input, determining a hand orientation associated with the touch input, and determining an adjusted position to associate with the touch input based at least in part on the determined hand orientation, and the position information associated with the touch input is disclosed.

A computer-readable medium encoded with instructions that, when executed by a computer, perform receiving indication of a touch input associated with a touch display, comprising position information associated with the touch input, determining a hand orientation associated with the touch input, and determining an adjusted position to associate with the touch input based at least in part on the determined hand orientation, and the position information associated with the touch input is disclosed.

A computer program product comprising a computer-readable medium bearing computer program code embodied therein for use with a computer, the computer program code comprising code for receiving indication of a touch input associated with a touch display, comprising position information associated with the touch input, code for determining a hand orientation associated with the touch input, and code for determining an adjusted position to associate with the touch input based at least in part on the determined hand orientation, and the position information associated with the touch input is disclosed.

### BRIEF DESCRIPTION OF THE DRAWINGS

For a more complete understanding of embodiments of the invention, reference is now made to the following descriptions taken in connection with the accompanying drawings in which:

FIGS. 1A-1B are diagrams illustrating examples of user intended positions of touch inputs and actual positions of touch inputs;

FIGS. 2A-2E are diagrams illustrating examples of a hand orientation associated with a touch input according to an example embodiment;

FIGS. 3A-3D are diagrams illustrating examples of sensors on an apparatus according to an example embodiment

FIGS. 4A-4D are diagrams illustrating examples of position information associated with a touch input and adjusted positions according to an example embodiment;

FIG. 5 is a flow diagram showing a set of operations for determining an adjusted position associated with a touch input according to an example embodiment;

FIG. 6 is another flow diagram showing a set of operations for determining an adjusted position associated with a touch input according to an example embodiment; and

FIG. 7 is a block diagram showing an apparatus according to an example embodiment.

### DETAILED DESCRIPTION OF THE DRAWINGS

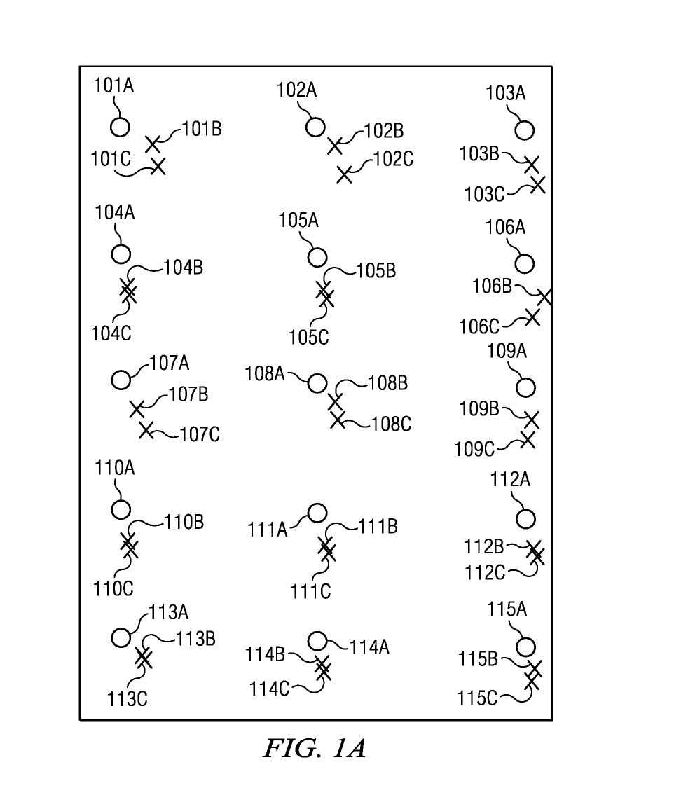

An embodiment of the invention and its potential advantages are understood by referring to FIGS. 1 through 7 of the drawings.

When a user performs a touch input on a touch display, the actual contact position of the touch input may vary from the user's intended contact position of the touch input. This variance may differ with regards various aspects associated with the touch input. For example, the variance may relate to an implement associated with performing the touch input, such as a finger, a thumb, a stylus, and/or the like. In another example, the variance may relate to the angle of the implement. In still another example, the variance may relate to the sidedness associated with the implement, such as left hand or right hand.

In an example embodiment, a device may determine an adjusted position associated with a touch input. Such an adjusted position may be utilized to improve correlation between a user's intended touch input contact position and the user's actual touch input contact position. For example, an apparatus may utilize an adjusted position associated with a touch input to draw a line, select a representation of information on the display, perform an operation, and/or the like.

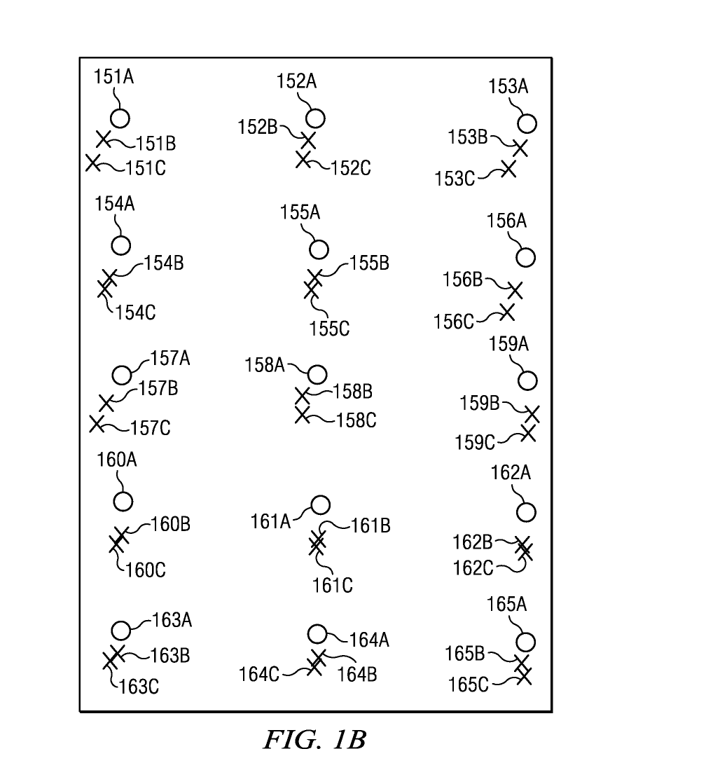

FIGS. 1A-1B are diagrams illustrating examples of user intended positions of touch inputs and actual positions of touch inputs. The examples of FIGS. 2A-2E are merely examples of positions and do not limit the invention. For example, a user may perform touch input with something other than a thumb or index finger. Furthermore, the variance between actual touch inputs and intended touch inputs may vary. Additionally, the number of touch inputs may vary.

FIG. 1A is a diagram illustrating examples of user intended touch input positions and actual touch input positions associated with right sided touch input. FIG. 1A illustrates examples of intended touch input positions in relation to actual right index finger touch input positions, and actual right thumb touch input positions. In the example of FIG. 1A, finger input 101B and thumb input 101C relate to intended input 101A, finger input 102B and thumb input 102C relate to intended input 102A, finger input 103B and thumb input 103C relate to intended input 103A, finger input 104B and thumb input 104C relate to intended input 104A, finger input 105B and thumb input 105C relate to intended input 105A, finger input 106B and thumb input 106C relate to intended input 106A, finger input 107B and thumb input 107C relate to intended input 107A, finger input 108B and thumb input 108C relate to intended input 108A, finger input 109B and thumb input 109C relate to intended input 109A, finger input 110B and thumb input 110C relate to intended input 110A, finger input 111B and thumb input 111C relate to intended input 111A, finger input 112B and thumb input 112C relate to intended input 112A, finger input 113B and thumb input 113C relate to intended input 113A, finger input 114B and thumb input 114C relate to intended input 114A, and finger input 115B and thumb input 115C relate to intended input 115A.

FIG. 1B is a diagram illustrating examples of user intended touch input positions and actual touch input positions associated with left sided touch input. FIG. 1B illustrates examples of intended touch input positions in relation to actual right index finger touch input positions, and actual right thumb touch input positions. In the example of FIG. 1B, finger input 151B and thumb input 151C relate to intended input 151A, finger input 152B and thumb input 152C relate to intended input 152A, finger input 153B and thumb input 153C relate to intended input 153A, finger input 154B and thumb input 154C relate to intended input 154A, finger input 155B and thumb input 155C relate to intended input 155A, finger input 156B and thumb input 156C relate to intended input 156A, finger input 157B and thumb input 157C relate to intended input 157A, finger input 158B and thumb input 158C relate to intended input 158A, finger input 159B and thumb input 159C relate to intended input 159A, finger input 160B and thumb input 160C relate to intended input 160A, finger input 161B and thumb input 161C relate to intended input 161A, finger input 162B and thumb input 162C relate to intended input 162A, finger input 163B and thumb input 163C relate to intended input 163A, finger input 164B and thumb input 164C relate to intended input 164A, and finger input 165B and thumb input 165C relate to intended input 165A.

Variation between a users intended touch input position and actual touch input position may vary across different apparatuses. Although there are many methods which may be utilized, and none of these methods serve to limit the invention, a person of ordinary skill in the art may obtain information regarding variance between intended touch input position and actual touch input position without undue experimentation by representing a target on a touch display, having a user perform a touch input on the target, and recording the position associated with the target and position information associated with the actual touch input. For example, a person of ordinary skill in the art may have a user perform touch inputs associated with targets at varying positions, with varying implements, with varying implement angles, with varying sidedness, and/or the like. An apparatus may be configured to perform a training process by having a user perform touch inputs associated with targets at varying positions, with varying implements, with varying implement angles, with varying sidedness, and/or the like, and storing position information associated with the intended touch input position and the actual touch input position.

FIGS. 2A-2E are diagrams illustrating examples of a hand orientation associated with a touch input according to an example embodiment. The examples of FIGS. 2A-2E are merely examples of contacts and do not limit the invention. For example, a different finger, part of finger, and/or the like may contact the touch display for the touch input. In another example, a different object, such as a book, a card, a ball, and/or the like, may contact the touch display for the touch input. In still another example, the device may be held and/or placed differently.

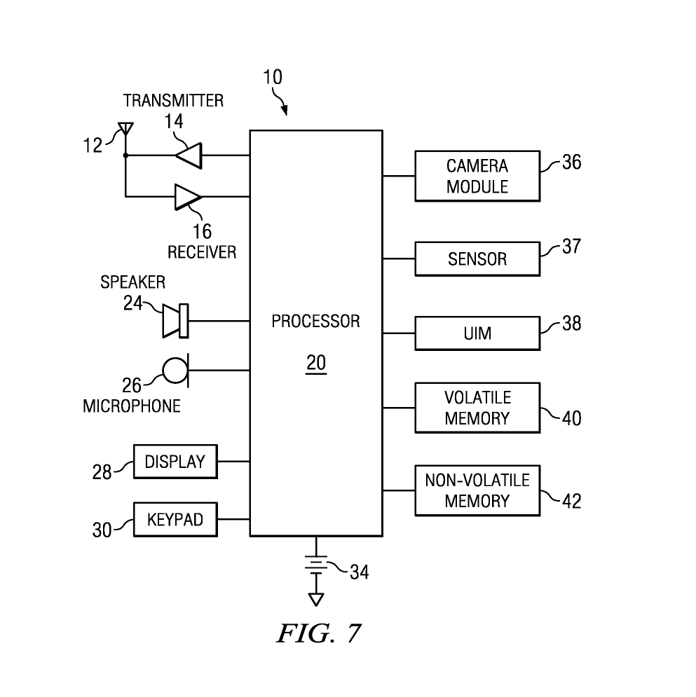

FIG. 2A is a diagram illustrating a tip 201 of a stylus 203 contacting a touch display 202, such as display 28 of FIG. 7, associated with a touch input according to an example embodiment. In the example of FIG. 2A, stylus 203 is held in a right hand and the device comprising touch display 202 is resting on a surface, such as a table, a desk, a floor, and/or the like. Stylus 203 may be a device designed to be a stylus, or may be a device merely used similarly to a stylus, such as a pen, a pencil, a pointer, and/or the like.

FIG. 2B is a diagram illustrating a finger tip 221 of a right hand contacting a touch display 222, such as display 28 of FIG. 7, associated with a touch input according to an example embodiment. In the example of FIG. 2B, the device comprising touch display 222 is held by a left hand. Although the example of FIG. 2B illustrates the tip of an index finger, one or more other finger tips, such as a middle finger tip, may perform contact.

FIG. 2C is a diagram illustrating a finger pad 241 of a left hand contacting a touch display 242, such as display 28 of FIG. 7, associated with a touch input according to an example embodiment. In an example embodiment, finger pad 241 relates to a region of the finger between the tip of the finger and the joint of the finger closest to the tip. In the example of FIG. 2C, the device comprising touch display 242 is held by a right hand. Although the example of FIG. 2C illustrates the pad of an index finger, one or more other finger pads, such as a ring finger pad, may perform contact.

FIG. 2D is a diagram illustrating a finger tip 261 of a right hand contacting a touch display 262, such as display 28 of FIG. 7, associated with a touch input according to an example embodiment. In the example of FIG. 2D, the device comprising touch display 262 is held by a left hand. Although the example of FIG. 2D illustrates the tip of an index finger, one or more other finger tips, such as a thumb tip, may perform contact.

FIG. 2E is a diagram illustrating a thumb pad 281 of a left hand and a thumb pad 283 of a right hand contacting a touch display 282, such as display 28 of FIG. 7, associated with a multiple touch input according to an example embodiment. In an example embodiment, thumb pad 281 and thumb pad 283 relate to a region of the thumb between the tip of the thumb and the joint of the thumb closest to the tip. In the example of FIG. 2E, the device comprising touch display 282 is held by a left hand and a right hand. Although the example of FIG. 2E illustrates the pad of a thumb, one or more other finger pads, such as an index finger pad, may perform contact.

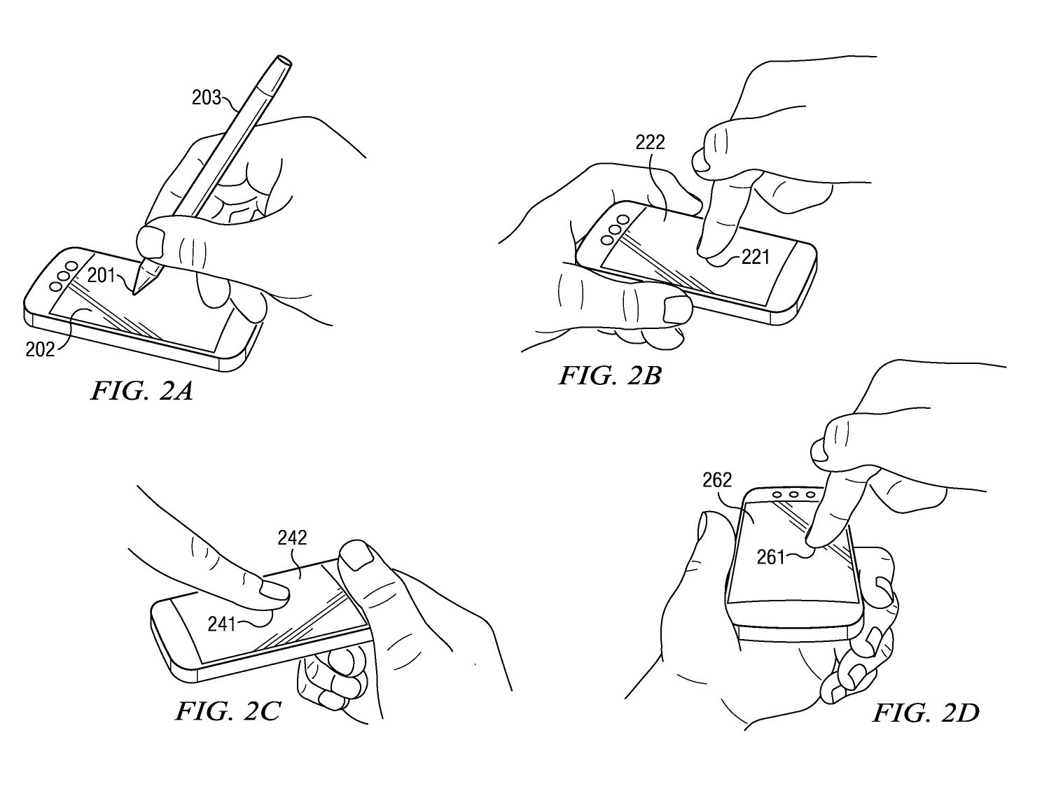

FIGS. 3A-3D are diagrams illustrating examples of sensors on an apparatus, for example, device 10 of FIG. 7, according to an example embodiment. The examples of FIGS. 3A-3D are merely examples, and do not limit the claims below. For example, the number and placement of sensors may differ from the examples of FIGS. 3A-3D. Without limiting the scope, interpretation, or application of the claims, some of the many technical effects of the sensors may be, but are not limited to, improving speed, accuracy, and reliability of and/or facilitating determining hand orientation associated with a touch input.

In the examples of FIGS. 3A-3D, the sensors are located on the apparatus to facilitate determination of information associated with hand placement of a user. Location of the sensors may vary across embodiments as illustrated, but not limited to, the examples of FIGS. 3A-3D. The sensors may be located to determine information associated with a hand holding the apparatus, a hand performing a touch input, and/or the like. For example, the sensors may be located to provide for determination of an angle associated with the touch input. In such an example, the angle associated with the touch input may relate to the angle of a stylus contacting a touch display, a finger contacting a touch display, a thumb contacting a touch display, and/or the like. In another example, the sensors may be located to provide for determination of sidedness associated with the touch input. In such an example, determining sidedness may relate to determining sidedness associated with holding the apparatus, associated with performing the touch input, and/or the like. Determining sidedness associated with performing the touch input may relate to determining sidedness of a hand holding a stylus, a finger performing the touch input. Sidedness may relate to the sidedness as related to the user or sidedness as related to the apparatus. For example, the apparatus may determine which side of the apparatus is being held, without regard for whether the hand holding the apparatus is the user's left hand or right hand. In such an example, the sidedness relates to the apparatus instead of the user.

The sensors of FIGS. 3A-3D relate to sensors, such as sensor 37 of FIG. 7, capable of determining at least one aspect of the environment surrounding and/or in contact with the apparatus. The sensors may comprise proximity sensors, light sensors, touch sensors, heat sensors, humidity sensors, optical sensors, and/or the like.

Although the examples of FIGS. 3A-3D relate to an apparatus comprising multiple sensors, an example embodiment may comprise a single sensor. In such an embodiment, the sensor may be located and/or configured in such a way that hand orientation information may be determined in the absence of multiple sensors, such as a touch sensor surrounding the apparatus, surrounding a touch display, and/or the like. In an example embodiment, the sensor may be the touch display itself. For example, a capacitive touch display may be configured to provide information associated with part of the touch display outside of a contact region associated with the touch input. Such configuration may provide information associated with hand placement of the user, such as an angle associated with the touch input.

FIG. 3A is a diagram illustrating examples of sensors 310-315 on an apparatus 301, for example, device 10 of FIG. 7, comprising a touch display 302, according to an example embodiment. In the example of FIG. 3A, sensors 310-315 are located surrounding the touch display 302 on half of the face of apparatus 301.

When receiving a touch input with a hand placement such as shown in the example of FIG. 2A, sensors 310-315 may provide information to the apparatus associated with the hand placement. For example, if apparatus 301 is positioned so that the hand performing the touch input on the device is on the side of apparatus 301 comprising sensors 310-315, sensors 313 and 314 may provide sensor information relating to contact, proximity, and/or the like. In such an example, sensors 310-312, and 315 may provide sensor information relating to lack of contact, proximity, and/or the like. In another example, if apparatus 301 is positioned so that the hand performing the touch input is on the side opposite to the side of apparatus 301 comprising sensors 310-315, sensors 310-315 may provide sensor information relating to lack of contact, proximity, and/or the like.

When receiving a touch input with a hand placement such as shown in the example of FIG. 2B, sensors 310-315 may provide information to the apparatus associated with the hand placement. For example, sensors 310-315 may provide sensor information relating to lack of contact, proximity, and/or the like.

When receiving a touch input with a hand placement such as shown in the example of FIG. 2C, sensors 310-315 may provide information to the apparatus associated with the hand placement. For example, if apparatus 301 is positioned so that the hand holding the device is on the side opposite the side of apparatus 301 comprising sensors 310-315, sensor 311 may provide sensor information relating to contact, proximity, and/or the like. In such an example, sensors 310 and 312-315 may provide sensor information relating to lack of contact, proximity, and/or the like. In another example, if apparatus 301 is positioned so that the hand holding the device is on the side of apparatus 301 comprising sensors 310-315, sensors 312 and 313 may provide sensor information relating to contact, proximity, and/or the like. In such an example, sensors 310, 311, 314, and 315 may provide sensor information relating to lack of contact, proximity, and/or the like.

When receiving a touch input with a hand placement such as shown in the example of FIG. 2D, sensors 310-315 may provide information to the apparatus associated with the hand placement. For example, sensors 310-315 may provide sensor information relating to lack of contact, proximity, and/or the like.

When receiving a touch input with a hand placement such as shown in the example of FIG. 2E, sensors 310-315 may provide information to the apparatus associated with the hand placement. For example, if apparatus 301 is positioned so that the left hand is on the side of apparatus 301 comprising sensors 310-315, sensor 314 may provide sensor information relating to contact, proximity, and/or the like. In such an example, sensors 310-313, and 315 may provide sensor information relating to lack of contact, proximity, and/or the like. In another example, if apparatus 301 is positioned so that the right hand is on the side of apparatus 301 comprising sensors 310-315, sensor 312 may provide sensor information relating to contact, proximity, and/or the like. In such an example, sensors 310, 311, and 313-315 may provide sensor information relating to lack of contact, proximity, and/or the like.

FIG. 3B is a diagram illustrating examples of sensors 323 and 324 on an apparatus 321, for example, device 10 of FIG. 7, comprising a touch display 322, according to an example embodiment. In the example of FIG. 3B, sensors 323 and 324 are located on opposite sides of apparatus 321.

When receiving a touch input with a hand placement such as shown in the example of FIG. 2A, sensors 323 and 324 may provide information to the apparatus associated with the hand placement. For example, sensors 323 and 324 may provide sensor information relating to lack of contact, proximity, and/or the like.

When receiving a touch input with a hand placement such as shown in the example of FIG. 2B, sensors 323 and 324 may provide information to the apparatus associated with the hand placement. For example, if apparatus 321 is positioned so that the hand holding the device is on the side of apparatus 321 comprising sensors 323 and 324, sensors 323 and 324 may provide sensor information relating to contact, proximity, and/or the like. In another example, if apparatus 321 is positioned so that the hand holding the device is on the side opposite to the side of apparatus 321 comprising sensors 323 and 324, sensors 323 and 324 may provide sensor information relating to lack of contact, proximity, and/or the like.

When receiving a touch input with a hand placement such as shown in the example of FIG. 2C, sensors 323 and 324 may provide information to the apparatus associated with the hand placement. For example, if apparatus 321 is positioned so that the hand holding the device is on the side of apparatus 321 comprising sensors 323 and 324, sensor 323 may provide sensor information relating to contact, proximity, and/or the like. In such an example, sensor 324 may provide sensor information relating to lack of contact, proximity, and/or the like. In another example, if apparatus 321 is positioned so that the hand holding the device is on the side opposite to the side of apparatus 321 comprising sensors 323 and 324, sensors 323 and 324 may provide sensor information relating to lack of contact, proximity, and/or the like.

When receiving a touch input with a hand placement such as shown in the example of FIG. 2D, sensors 323 and 324 may provide information to the apparatus associated with the hand placement. For example, if apparatus 321 is positioned so that the hand holding the device is on the side of apparatus 321 comprising sensors 323 and 324, sensors 323 and 324 may provide sensor information relating to contact, proximity, and/or the like. In another example, if apparatus 321 is positioned so that the hand holding the device is on the side opposite to the side of apparatus 321 comprising sensors 323 and 324, sensors 323 and 324 may provide sensor information relating to lack of contact, proximity, and/or the like.

When receiving a touch input with a hand placement such as shown in the example of FIG. 2E, sensors 323 and 324 may provide information to the apparatus associated with the hand placement. For example, if apparatus 321 is positioned so that the right hand is on the side of apparatus 321 comprising sensors 323 and 324, sensors 323 and 324 may provide sensor information relating to lack of contact, proximity, and/or the like. In another example, if apparatus 321 is positioned so that the left hand is on the side of apparatus 321 comprising sensors 323 and 324, sensor 324 may provide sensor information relating to contact, proximity, and/or the like. In such an example, sensor 323 may provide sensor information relating to lack of contact, proximity, and/or the like.

FIG. 3C is a diagram illustrating examples of sensors 343, 344, and 350-355 on an apparatus 341, for example, device 10 of FIG. 7, comprising a touch display 342, according to an example embodiment. In the example of FIG. 3B, sensors 343-344 are located on opposite sides of apparatus 341 and sensors 350-355 are located surrounding the touch display 342 on half of the face of apparatus 341.

When receiving a touch input with a hand placement such as shown in the example of FIG. 2A, sensors 343, 344, and 350-355 may provide information to the apparatus associated with the hand placement. For example, if apparatus 341 is positioned so that the hand performing the touch input is on the side of apparatus 341 comprising sensors 343, 344, and 350-355, sensors 353 and 354 may provide sensor information relating to contact, proximity, and/or the like. In such an example, sensors 343, 344, 350-352, and 355 may provide sensor information relating to lack of contact, proximity, and/or the like. In another example, if apparatus 341 is positioned so that the hand performing the touch input is on the side opposite to the side of apparatus 341 comprising sensors 343, 344, and 350-355, sensors 343, 344, and 350-355 may provide sensor information relating to lack of contact, proximity, and/or the like.

When receiving a touch input with a hand placement such as shown in the example of FIG. 2B, sensors 343, 344, and 350-355 may provide information to the apparatus associated with the hand placement. For example, if apparatus 341 is positioned so that the hand holding the device is on the side of apparatus 341 comprising sensors 343, 344, and 350-355, sensors 343 and 344 may provide sensor information relating to contact, proximity, and/or the like. In such an example, sensors 350-355 may provide sensor information relating to lack of contact, proximity, and/or the like. In another example, if apparatus 341 is positioned so that the hand holding the device is on the side opposite to the side of apparatus 341 comprising sensors 343 and 344, sensors 343, 344 and 350-355 may provide sensor information relating to lack of contact, proximity, and/or the like.

When receiving a touch input with a hand placement such as shown in the example of FIG. 2C, sensors 343, 344, and 350-355 may provide information to the apparatus associated with the hand placement. For example, if apparatus 341 is positioned so that the hand holding the device is on the side of apparatus 341 comprising sensors 343, 344, and 350-355, sensors 343, 352, and 353 may provide sensor information relating to contact, proximity, and/or the like. In such an example, sensors 344, 350, 351, 354, and 355 may provide sensor information relating to lack of contact, proximity, and/or the like. In another example, if apparatus 341 is positioned so that the hand holding the device is on the side opposite to the side of apparatus 341 comprising sensors 343, 344, and 350-355, sensor 343, 344, 350, 352, 353, 354, and 355 may provide sensor information relating to lack of contact, proximity, and/or the like. In such an example, sensor 351 may provide sensor information relating to contact, proximity, and/or the like.

When receiving a touch input with a hand placement such as shown in the example of FIG. 2D, sensors 343, 344, and 350-355 may provide information to the apparatus associated with the hand placement. For example, if apparatus 341 is positioned so that the hand holding the device is on the side of apparatus 341 comprising sensors 343, 344, and 350-355, sensors 343 and 344 may provide sensor information relating to contact, proximity, and/or the like. In such an example, sensors 350-355 may provide sensor information relating to lack of contact, proximity, and/or the like. In another example, if apparatus 341 is positioned so that the hand holding the device is on the side opposite to the side of apparatus 341 comprising sensors 343, 344, and 350-355, sensors 343, 344, 350-355 may provide sensor information relating to lack of contact, proximity, and/or the like.

When receiving a touch input with a hand placement such as shown in the example of FIG. 2E, sensors 343, 344, and 350-355 may provide information to the apparatus associated with the hand placement. For example, if apparatus 341 is positioned so that the right hand is on the side of apparatus 341 comprising sensors 343, 344, and 350-355, sensors 343, 344, 350, 351, 353, 354, and 355 may provide sensor information relating to lack of contact, proximity, and/or the like. In such an example, sensor 352 may provide sensor information relating to contact, proximity, and/or the like. In another example, if apparatus 341 is positioned so that the left hand is on the side of apparatus 341 comprising sensors 343, 344, and 350-355, sensors 344 and 354 may provide sensor information relating to contact, proximity, and/or the like. In such an example, sensors 343, 350, 351, 352, 353, and 355 may provide sensor information relating to lack of contact, proximity, and/or the like.

FIG. 3D is a diagram illustrating examples of sensors 371-378 and 380-389 on an apparatus 361, for example, device 10 of FIG. 7, comprising a touch display 362, according to an example embodiment. In the example of FIG. 3D, sensors 371-378 are located sides of apparatus 361 and sensors 380-389 are located surrounding the touch display 362 on the face of apparatus 361.

When receiving a touch input with a hand placement such as shown in the example of FIG. 2A, sensors 371-378 and 380-389 may provide information to the apparatus associated with the hand placement. For example, sensors 383 and 384 may provide sensor information relating to contact, proximity, and/or the like. In such an example, sensors 371-379, 380-382, and 385-389 may provide sensor information relating to lack of contact, proximity, and/or the like.

When receiving a touch input with a hand placement such as shown in the example of FIG. 2B, sensors 371-378 and 380-389 may provide information to the apparatus associated with the hand placement. For example, sensors 371-374 may provide sensor information relating to contact, proximity, and/or the like. In such an example, sensors 375-379 and 380-389 may provide sensor information relating to lack of contact, proximity, and/or the like.

When receiving a touch input with a hand placement such as shown in the example of FIG. 2C, sensors 371-378 and 380-389 may provide information to the apparatus associated with the hand placement. For example, sensors 375, 376, 381, 387, and 388 may provide sensor information relating to contact, proximity, and/or the like. In such an example, sensors 371-374, 377, 378, 380, 382-386, and 389 may provide sensor information relating to lack of contact, proximity, and/or the like.

When receiving a touch input with a hand placement such as shown in the example of FIG. 2D, sensors 371-378 and 380-389 may provide information to the apparatus associated with the hand placement. For example, sensors 371 and 374 may provide sensor information relating to contact, proximity, and/or the like. In such an example, sensors 372, 373, 375-378, and 380-389 may provide sensor information relating to lack of contact, proximity, and/or the like.

When receiving a touch input with a hand placement such as shown in the example of FIG. 2E, sensors 371-378 and 380-389 may provide information to the apparatus associated with the hand placement. For example, sensors 371, 372, 375, 377, 378, 380-386, 388, and 389 may provide sensor information relating to lack of contact, proximity, and/or the like. In such an example, sensors 373, 374, 376, 384, and 387 may provide sensor information relating to contact, proximity, and/or the like.

In an example embodiment, there may be circumstances where the apparatus is able to determine hand orientation associated with a touch input and circumstances where the apparatus is unable to determine hand orientation associated with a touch input. In circumstances where the apparatus is able to determine hand orientation associated with a touch input, the apparatus may determine an adjusted position associated with the touch input based at least in part on the determined hand orientation. In circumstances where the apparatus is unable to determine hand orientation, the apparatus may utilize a default adjusted position, a lack of adjustment, an adjusted position based at least in part on a default hand orientation, and/or the like.

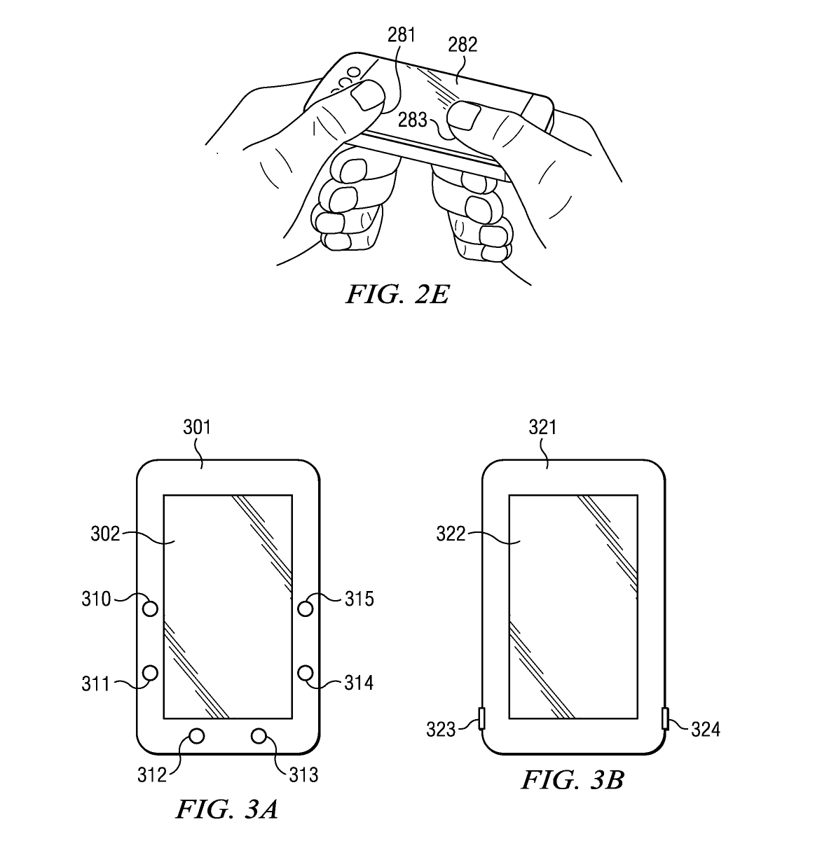

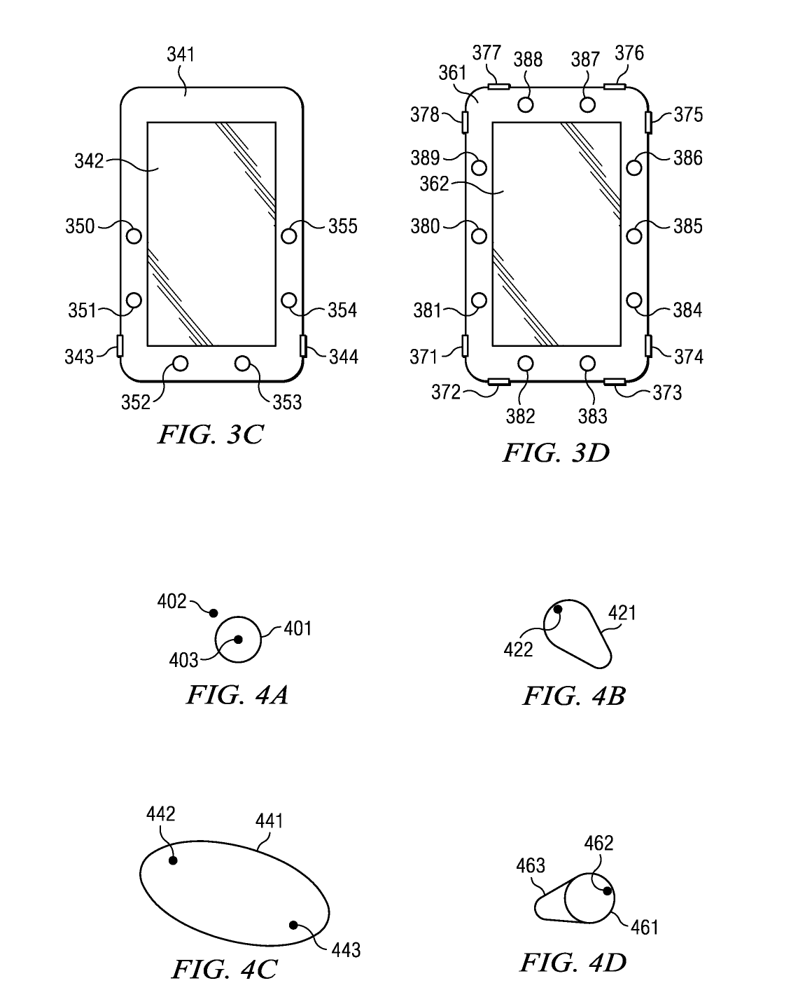

FIGS. 4A-4D are diagrams illustrating examples of position information associated with a touch input and adjusted positions according to an example embodiment. The examples of FIGS. 4A-4D are merely examples, and do not limit the claims below. For example, the adjusted position may differ from the examples of FIGS. 4A-4D. In an embodiment, there is a contact region associated with the touch input that relates to a region associated with a touch input contact to a touch display, such as display 28 of FIG. 7. In an embodiment, position information associated with touch input is based on position information associated with the contact region. For example, position information associated with a touch input may relate to an area of a touch display corresponding to a position of a contact region. In another example, position information associated with a touch input may relate to a determination of position information of a point in relation to the contact region. Such determination may relate to determination of a geometric center, a cross sectional center, a calculation based on finger shape, and/or the like. In an embodiment, an adjusted position relates to a determination regarding probable user position intent associated with a touch input. Such determination may be similar as described with reference to block 503 of FIG. 5. Without limiting the scope, interpretation, or application of the claims, some of the technical effects of interpreting the information associated with a contact region may be, but are not limited to, improving speed, accuracy, and reliability of determining hand orientation associated with a touch input, of determining position information associated with a touch input, and determining an adjusted position to associate with the touch input.

FIG. 4A is a diagram illustrating an example of position information associated with a touch input indicated by contact region 401 and adjusted positions 402 and 403. The example of FIG. 4A may relate to a touch input performed similar to FIG. 2A, FIG. 2B, FIG. 2D, and/or the like. An apparatus may determine adjusted positions in conjunction with each other or alternatively to each other. For example, the apparatus may determine adjusted position 402 without determining adjusted position 403. In another example, the apparatus may determine adjusted position 402 and adjusted position 403. In yet another example, the apparatus may determine adjusted position 403 without determining adjusted position 402. Adjusted position 402 may relate to a determination similar as described with reference to block 503 of FIG. 5, where the determined adjusted position relates to a position above to the left of contact region 401. Adjusted position 403 may relate to a determination similar as described with reference to block 503 of FIG. 5, where the determined adjusted position relates to a position in the center of contact region 401. In such an example, the determined adjusted position may relate to a determined lack of adjustment. For example, an apparatus may determine, based on information associated with the touch input, such as contact region, sensor information, and/or the like, that no adjustment should be made to the position information such that the adjusted position is substantially the same as the position information associated with the touch input.

FIG. 4B is a diagram illustrating an example of position information associated with a touch input indicated by contact region 421 and adjusted position 422 according to an example embodiment. The example of FIG. 4B may relate to a touch input performed similar to FIG. 2C, FIG. 2E, and/or the like. Adjusted position 422 may relate to a determination similar as described with reference to block 503 of FIG. 5, where the determined adjusted position relates to a position within the upper left part of contact region 421. In an example embodiment, an apparatus may determine that contact region 421 is associated with a hand orientation related to a right hand performing a touch input based on the rightward tapering of the contact region. Such tapering may indicate a direction, angle, sidedness, and/or the like associated with the touch input.

FIG. 4C is a diagram illustrating an example of position information associated with a touch input indicated by contact region 441 and adjusted position 442 according to an example embodiment. The example of FIG. 4C may relate to a touch input performed similar to FIG. 2C, FIG. 2E, and/or the like. An apparatus may determine adjusted positions in conjunction with each other or alternatively to each other. For example, the apparatus may determine adjusted position 442 without determining adjusted position 443. In another example, the apparatus may determine adjusted position 442 and adjusted position 443. In yet another example, the apparatus may determine adjusted position 443 without determining adjusted position 442. Adjusted position 442 may relate to a determination similar as described with reference to block 503 of FIG. 5, where the determined adjusted position relates to a position within the upper left part of contact region 441. Adjusted position 443 may relate to a determination similar as described with reference to block 503 of FIG. 5, where the determined adjusted position relates to a position within the lower right part of contact region 441. In an embodiment, an apparatus may determine adjusted position 442 or 443 based, at least in part, on a determined hand orientation. For example, the apparatus may determine adjusted position 443 based on a determined hand orientation relating to a left hand touch input. In another example, the apparatus may determine adjusted position 442 based on a determined hand orientation relating to a right hand touch input. In still another example, the apparatus may determine adjusted position 442 based on a determined hand orientation relating to a left hand holding the apparatus.

FIG. 4E is a diagram illustrating an example of position information associated with a touch input indicated by contact region 461 and adjusted position 462 according to an example embodiment. Proximity region 463 relates to an uncontacted part of the touch display that is associated with proximity of an implement associated with the touch input, such as a finger, stylus, thumb, and/or the like. In an example embodiment, a touch display, such as a capacitive touch display, may provide proximity information associated with an uncontacted part of the touch display. The example of FIG. 4E may relate to a touch input performed similar to FIG. 2C, FIG. 2E, and/or the like. Adjusted position 462 may relate to a determination similar as described with reference to block 503 of FIG. 5, where the determined adjusted position relates to a position within the upper left part of contact region 461. In an example embodiment, an apparatus may determine that contact region 461 is associated with a hand orientation related to a left hand performing a touch input based on the leftward tapering of the proximity region. Such tapering may indicate a direction, angle, sidedness, and/or the like associated with the touch input.

In an embodiment, an apparatus may vary adjusted position between different touch inputs based, at least in part, on different hand orientation associated with the touch inputs. For example, the apparatus may determine a first adjusted position associated with a contact position for a touch input associated with a right thumb input and a left hand holding the bottom of the apparatus. In such an example, the apparatus may determine a second adjusted position associated with the same contact position for a different touch input associated with a right thumb input and a left hand holding the top of an apparatus.

FIG. 5 is a flow diagram showing a set of operations 500 for determining an adjusted position associated with a touch input according to an example embodiment. An apparatus, for example electronic device 10 of FIG. 7, may utilize the set of operations 500. The apparatus may comprise means, including, for example, the processor 20, for performing the operations of FIG. 8. In an example embodiment, an apparatus, for example device 10 of FIG. 7 is transformed by having memory, for example memory 42 of FIG. 7, comprising computer code configured to, working with a processor, for example processor 20 of FIG. 7, cause the apparatus to perform set of operations 500.

At Block 501, the apparatus receives indication of a touch input associated with a touch display, such as display 28 of FIG. 7, comprising position information associated with the touch input. The apparatus may receive indication of the touch input by retrieving information from one or more memories, such as non-volatile memory 42 of FIG. 7, receiving one or more indications of the touch input from a part of the apparatus, such as a display, for example display 28 of FIG. 7, receiving indication of the touch input from a receiver, such as receiver 16 of FIG. 7, and/or the like. In an example embodiment, the apparatus may receive the touch input from a different apparatus comprising a display, such as an external monitor. The position information associated with the touch input may relate to a contact region associated with the touch input, a position related to a touch display associated with a touch input, and/or the like. The touch input may relate to a multiple touch input such as a touch input associated with FIG. 2E.

At Block 502, the apparatus determines a hand orientation associated with the touch input. The hand orientation may relate to an input implement, such as a finger, a thumb, a stylus, and/or the like. Additionally or alternatively, the hand orientation may relate to an angle associated with the input implement. Additionally or alternatively, the hand orientation may relate to the sidedness, such as right or left, of a hand associated with the input implement, the sidedness of a hand associated with holding the apparatus, the lack of a hand holding the apparatus, and/or the like. The apparatus may determine hand orientation based, at least in part, on size, shape, orientation, and/or the like of a contact region associated with a touch input. Additionally or alternatively, the apparatus may determine hand orientation based, at least in part, on sensor information provided by one or more sensors, such sensor 37 of FIG. 7, sensors 310-315 of FIG. 3A, sensors 323 and 324 of FIG. 3B, sensors 343, 344, and 350-355 of FIG. 3C, sensors 371-378 and 380-389 of FIG. 3D, and/or the like. Such sensor information may relate to proximity information, contact information, light information, and/or the like. Without limiting the scope, interpretation, or application of the claims, one of many technical effects of determining hand orientation associated with a touch input may be to improve speed, accuracy, and reliability of, and/or facilitate determining an adjusted position associated with a touch input.

At Block 503, the apparatus determines an adjusted position to associate with the touch input based at least in part on the determined hand orientation, and the position information associated with the touch input. The adjusted position may relate to the touch input as described with reference to FIGS. 4A-4C. The apparatus may determine the adjusted position by performing a calculation, retrieving a predetermined value, and/or the like. The predetermined value may be stored in memory, such as memory 42 of FIG. 7, determined during a training process, and/or the like. For example, an apparatus may perform a calculation to determine adjusted position based on a determined hand orientation related to a right hand input. In such an example, the apparatus may perform a different calculation to determine adjusted position based on a determine hand orientation related to a right hand holding the apparatus. In another example, the apparatus my perform a calculation to determine adjusted position that evaluates multiple aspects of hand orientation, such as sidedness of a hand associated with the input implement, sidedness of a hand associated with holding the apparatus, lack of a hand holding the apparatus, angle of input implement, and/or the like.

In an example embodiment, an apparatus may retrieve one or more predetermined position adjustment values associated with one or more hand orientations, then apply the position adjustment to the position information associated with the touch input to determine the adjusted position. For example, the apparatus may retrieve a predetermined position adjustment information based on position information associated with the touch input and a hand orientation of a right hand wielding an index finger tip and a left hand holding the apparatus. In another example, the apparatus may retrieve a predetermined position adjustment based on a contact region shape and position information associated with the touch input.

In an example embodiment, the adjusted position may be identical to the position information associated with the touch input. In such an example, determination of absence of adjustment may relate to accuracy of a hand orientation and/or input implement that may have a related insignificant difference between intended position of touch input and actual position of touch input. For example, a stylus may have an insignificant difference between a user's intended touch input position and actual touch input position.

Without limiting the scope, interpretation, or application of the claims, one of many technical effects of determining an adjusted position associated with a touch input may be to improve speed, accuracy, and reliability of, and/or facilitate touch input. For example, the user may be able to perform input less meticulously. In another example, the user may encounter fewer errors associated with touch input position, thus reducing the corrective action and/or repeated touch input from the user and associated processing of the apparatus. Another such technical effect may be to allow an apparatus to increase resolution of touch input. For example, an apparatus may rely on improved touch input accuracy to increase screen resolution, decrease user interface element size, and/or the like, without negatively impacting the user.

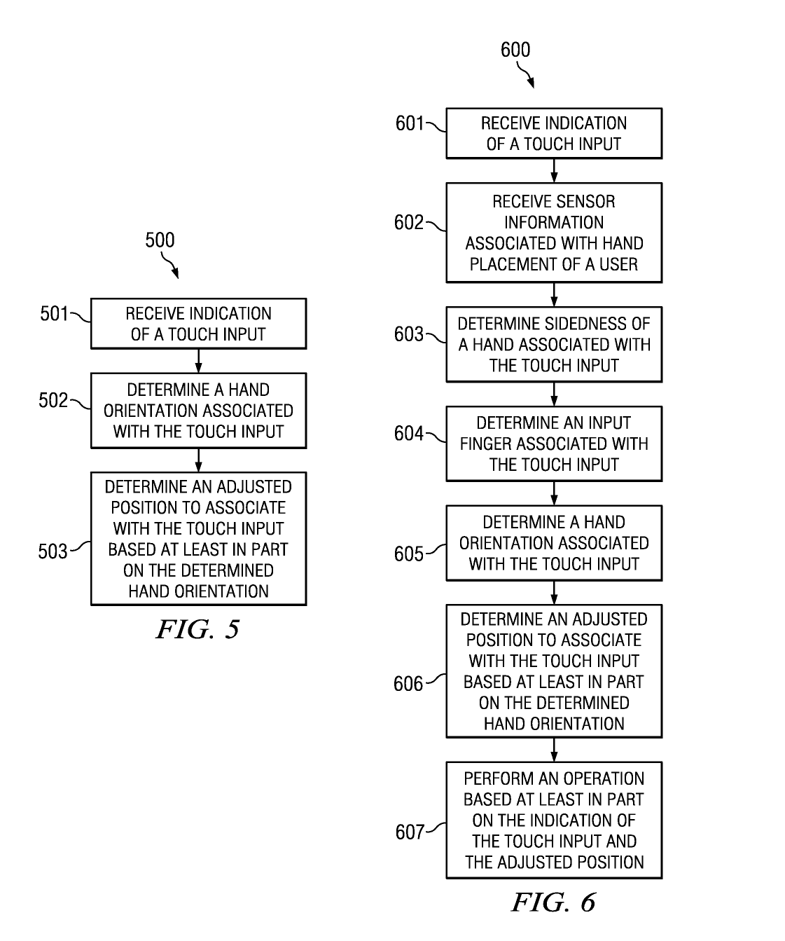

FIG. 6 is another flow diagram showing a set of operations 600 for determining an adjusted position associated with a touch input according to an example embodiment. An apparatus, for example electronic device 10 of FIG. 7, may utilize the set of operations 600. The apparatus may comprise means, including, for example, the processor 20, for performing the operations of FIG. 8. In an example embodiment, an apparatus, for example device 10 of FIG. 7 is transformed by having memory, for example memory 42 of FIG. 7, comprising computer code configured to, working with a processor, for example processor 20 of FIG. 7, cause the apparatus to perform set of operations 600.

At Block 601, the apparatus receives indication of a touch input associated with a touch display, such as display 28 of FIG. 7, comprising position information associated with the touch input. The operation of block 601 is similar as described with reference to block 501 of FIG. 5.

At Block 602, the apparatus receives sensor information associated with hand placement of a user. The sensor information may be received from one or more sensors. The apparatus may comprise the one or more sensors, such as sensor 37 of FIG. 7, and/or the one or more sensors may be separate from the apparatus. In circumstances where the apparatus comprises the one or more sensors, the one or more sensors may be located on the apparatus so that they may provide information associated with user hand placement, such as illustrated, but not limited to, FIGS. 3A-3D. For example, the one or more sensors may be located to determine information associated with a hand holding the apparatus, located to determine information associated with a hand related to performing the touch input, and/or the like. The one or more sensors may determine light information, proximity information, contact information, and/or the like. For example, the one or more sensors may be a light sensor, a proximity sensor, a contact sensor, and/or the like, independently or in combination. In an example embodiment, a touch display, such as display 28 of FIG. 7, provide information associated with proximity related to a touch input, such as illustrated in the example of FIG. 4D. Without limiting the scope, interpretation, or application of the claims, some of the many technical effects of the sensor information associated with hand placement of a user may be, but are not limited to, improving speed, accuracy, and reliability of and/or facilitating determining hand orientation associated with a touch input.

At Block 603, the apparatus determines sidedness associated with the touch input. For example, the apparatus may determine sidedness of one or more hands holding the apparatus, sidedness of one or more hands associated with a touch input, and/or the like. For example, the apparatus may determine that a left hand is holding the apparatus. In another example, the apparatus may determine that a right hand in associated with a touch input. In still another example, the apparatus may determine that a right hand is holding the apparatus and the right hand is associated with a touch input. In a further example, the apparatus may determine that a right hand is holding the apparatus and a left hand is associated with a touch input. The apparatus may determine sidedness similar as described with reference to FIGS. 3A-3D, 4B, and 4D. Without limiting the scope, interpretation, or application of the claims, some of the many technical effects of determining sidedness associated with the touch input may be, but are not limited to, improving speed, accuracy, and reliability of and/or facilitating determining hand orientation associated with a touch input.

At Block 604, the apparatus determines an input finger associated with the touch input. Determination of an input finger may be based, at least in part, on size of contact region associated with the touch input, orientation of a contact region associated with the touch input, sensor information associated with the touch input, and/or the like. For example, the apparatus may determine that a thumb is associated with the touch input based, at least in part on sensor information indicating that two hands are holding the apparatus. In another example, the apparatus may determine that an index finger is associated with the touch input based at least in part on the size of a contact region associated with the touch input. In such an example, the apparatus may store contact region information associated with various touch inputs. Without limiting the scope, interpretation, or application of the claims, some of the many technical effects of determining an input finger associated with the touch input may be, but are not limited to, improving speed, accuracy, and reliability of and/or facilitating determining hand orientation associated with a touch input.

At Block 605, the apparatus determines a hand orientation based at least in part on the sensor information associated with the touch input, determine sidedness associated with the touch input, and/or input finger associated with the touch input. The operation of block 605 is similar as described with reference to block 502 of FIG. 5.

At Block 606, the apparatus determines an adjusted position to associate with the touch input based at least in part on the determined hand orientation, and the position information associated with the touch input. The operation of block 606 is similar as described with reference to block 503 of FIG. 5.

At Block 607, the apparatus performs an operation based at least in part on the indication of the touch input and the adjusted position. The operation may relate to an information item, such as an icon, a file, a video, audio, an image, text information, and/or the like. The operation may relate to selecting an information item, inputting information, modifying information, deleting information, and/or the like. In an example embodiment, the operation may relate to sending the input information to a separate apparatus. For example, in an embodiment, the apparatus may provide input and display capabilities for the separate apparatus such that the separate apparatus sends information to the apparatus for display and the apparatus sends information to the separate apparatus for input.

FIG. 7 is a block diagram showing an apparatus, such as an electronic device 10, according to an example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna, (or multiple antennae), a wired connector, and/or the like in operable communication with a transmitter 14 and a receiver 16. The electronic device 10 may further comprise a processor 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with wireline protocols, such as Ethernet, digital subscriber line (DSL), asynchronous transfer mode (ATM), second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry, for implementing audio, video, communication, navigation, logic functions, and/or the like, as well as for implementing embodiments of the invention including, for example, one or more of the functions described in conjunction with FIGS. 1-6. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1-6. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 1-6. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1-7. For example, the memories may comprise an identifier, such as an international mobile equipment identification (IMEI) code, which may uniquely identify the electronic device 10.

Electronic device 10 may comprise one or more sensor 37. Sensor 37 may comprise a light sensor, a proximity sensor, a motion sensor, a location sensor, and/or the like. For example, sensor 37 may comprise one or more light sensors at various locations on the device. In such an example, sensor 37 may provide sensor information indicating an amount of light perceived by one or more light sensors. Such light sensors may comprise a photovoltaic element, a photoresistive element, a charge coupled device (CCD), and/or the like. In another example, sensor 37 may comprise one or more proximity sensors at various locations on the device. In such an example, sensor 37 may provide sensor information indicating proximity of an object, a user, a part of a user, and/or the like, to the one or more proximity sensors. Such proximity sensors may comprise capacitive measurement, sonar measurement, radar measurement, and/or the like.

Although FIG. 7 illustrates an example of an electronic device that may utilize embodiments of the invention including those described and depicted, for example, in FIGS. 1-6, electronic device 10 of FIG. 7 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 7. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 603 of FIG. 6 may be performed after block 604 of FIG. 6. Furthermore, if desired, one or more of the above-described functions may be optional or may be combined. For example, block 604 of FIG. 6 may be omitted or combined with block 605 of FIG. 6.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1. An apparatus, comprising:
at least one processor;
at least one memory including computer program code, the memory and the computer program code configured to, working with the processor, cause the apparatus to perform at least the following:
receiving indication of a touch input associated with a touch display, comprising position information associated with the touch input;
determining a hand orientation associated with the touch input; and
determining an adjusted position to associate with the touch input based at least in part on the determined hand orientation, and the position information associated with the touch input.

2. Cancelled.

3. The apparatus of claim 1, wherein the input information comprises information associated with a contact region and the determined hand orientation is based at least in part on the information associated with the contact region.

4. (canceled)

5. The apparatus of claim 1, wherein the determined positional adjustment relates to an absence of adjustment.

6. The apparatus of claim 1, wherein said memory and computer program code are further configured to, working with the processor, cause the apparatus to perform at least the following:
receiving sensor information associated with hand placement of a user; and
basing the determined hand orientation at least in part on the sensor information.

7. The apparatus of claim 6, further comprising at least one sensor for providing the sensor information.

8. The apparatus of claim 6, wherein the sensor information relates to sensors located to determine information associated with a hand holding the apparatus.

9. The apparatus of claim 6, wherein the sensor information relates to sensors located to determine information associated with a hand related to performing the touch input.

10. (canceled)

11. The apparatus of claim 6, wherein the sensor information relates to an uncontacted part of the touch display.

12. The apparatus of claim 6, wherein the sensor information relates to proximity information associated with a proximity sensor.

13. (canceled)

14. The apparatus of claim 6, wherein the sensor information relates to proximity information is associated with a part of the touch display outside of a contact region associated with the touch input.

15. The apparatus of claim 1, wherein said memory and computer program code are further configured to, working with the processor, cause the apparatus to perform at least the following:
determining sidedness associated with the touch input; and
basing the determined hand orientation at least in part on the determined sidedness.

16. The apparatus of claim 1, wherein said memory and computer program code are further configured to, working with the processor, cause the apparatus to perform at least the following:
determining an input finger associated with the touch input; and
basing the determined hand orientation at least in part on the determined input finger.

17. The apparatus of claim 1, wherein the determined hand orientation relates to an angle associated with a finger associated with the touch input.

18. The apparatus of claim 1, wherein determining the adjusted position comprises selecting a predetermined value based at least in part on the determined hand orientation.

19. The apparatus of claim 1, wherein determining the adjusted position comprises calculating a value based at least in part on the hand orientation.

20. The apparatus of claim 1, wherein said memory and computer program code are further configured to, working with the processor, cause the apparatus to perform an operation based at least in part on the indication of the touch input and the adjusted position.

21. The apparatus of claim 1, wherein the operation relates to the adjusted position and position information associated with a representation of an information item.

22-23. (canceled)

24. The apparatus of claim 1, wherein the apparatus further comprises the touch display.

25. A method, comprising:
receiving indication of a touch input associated with a touch display, comprising position information associated with the touch input;
determining a hand orientation associated with the touch input; and
determining an adjusted position to associate with the touch input based at least in part on the determined hand orientation, and the position information associated with the touch input.

26-46. (canceled)

47. A computer-readable medium encoded with instructions that, when executed by a computer, perform:
receiving indication of a touch input associated with a touch display, comprising position information associated with the touch input;
determining a hand orientation associated with the touch input; and
determining an adjusted position to associate with the touch input based at least in part on the determined hand orientation, and the position information associated with the touch input.

48-90. (canceled)
